(19) United States
(12) Patent Application Publication
(10) Pub. No.: US 2020/0020143 A1
(43) Pub. Date: Jan. 16, 2020

(54) SYSTEMS AND METHODS FOR IN-VEHICLE AUGMENTED VIRTUAL REALITY SYSTEM

(71) Applicant: GM GLOBAL TECHNOLOGY OPERATIONS LLC, Detroit, MI (US)

(72) Inventors: Xin Yu, Troy, MI (US); Fan Bai, Ann Arbor, MI (US); John Sergakis, Bloomfield Hills, MI (US)

(73) Assignee: GM GLOBAL TECHNOLOGY OPERATIONS LLC, Detroit, MI (US)

(21) Appl. No.: 16/034,045

(22) Filed: Jul. 12, 2018

(51) Int. Cl. G06T 11/60; B60K 35/00; B60R 1/00

(52) U.S. Cl. CPC G06T 11/60; B60K 35/00; B60R 2300/207; B60K 2350/1056; B60K 2350/1096; B60R 1/00

(57) ABSTRACT

Systems and methods are provided for entertaining a passenger of a vehicle by providing an immersive experience. In one embodiment, a method includes: receiving image data from a plurality of camera devices coupled to the vehicle, wherein the image data depicts an environment surrounding the vehicle; receiving point of interest data associated with the environment of the vehicle; fusing, by a processor, the image data and the point of interest data using a localization method; orienting, by a processor, the fused image data based on a position of a user device; and rendering, by a processor, the oriented, fused data on a virtual reality display of the user device.

### TECHNICAL FIELD

The present disclosure generally relates to virtual reality, and more particularly relates to systems and methods for integrating a virtual reality experience into a vehicle using multi-view cameras, sensor fusion, and point of interest information.

Vehicle perception systems include a number of cameras. The cameras are integrated into the vehicle body and capture the surrounding environment of the vehicle. Output from the cameras is analyzed in order to control the vehicle in an autonomous or partial autonomous manner.

The view of a rear seat passenger is typically restricted by the window size and location relative to the passenger. Thus, the passenger is unable to enjoy the full landscape along a road trip. Accordingly, it is desirable to provide systems and methods for leveraging the vehicle cameras in order to provide a virtual reality view of the landscape. It is further desirable to provide additional information to the passenger along the road trip. Furthermore, other desirable features and characteristics of the present disclosure will become apparent from the subsequent detailed description and the appended claims, taken in conjunction with the accompanying drawings and the foregoing technical field and background.

### SUMMARY

Systems and methods are provided for entertaining a passenger of a vehicle by providing an immersive experience. In one embodiment, a method includes: receiving image data from a plurality of camera devices coupled to the vehicle, wherein the image data depicts an environment surrounding the vehicle; receiving point of interest data associated with the environment of the vehicle; fusing, by a processor, the image data and the point of interest data using a localization method; orienting, by a processor, the fused image data based on a position of a user device; and rendering, by a processor, the oriented, fused data on a virtual reality display of the user device.

In various embodiments, the fusing is based on a probabilistic optimization method. In various embodiments, the fusing is further based on a fusing of inertia measurement unit data, global positioning system data, and the image data to determine a location, orientation, and speed of the vehicle in a first coordinate system. In various embodiments, the fusing is further based on fusing image data and inertia measurement data to obtain a result and fusing the result with global positioning system data.

In various embodiments, the fusing is based on a graph pose optimization. In various embodiments, the fusing is further based on fusing global positioning system data and inertia measurement unit data to obtain a result and fusing the result with the image data.

In various embodiments, the fusing is based on a graph pose optimization and an extended Kalman filter.

In various embodiments, the fusing further includes: fusing global positioning system data, inertia measurement unit data, camera data, and point of interest data into a single coordinate system; and transforming the fused data into a second coordinate system, wherein the second coordinate system is a of the user device. In various embodiments, the orienting comprises orienting the transformed data from the second coordinate system to a third coordinate system, where the third coordinate system is based on an orientation of the user device.

In various embodiments, the point of interest data includes at least one of a name, a logo, an address, contact information, sales information, hours of operation, historical facts relative to the point.

In another embodiment, a virtual reality system for a vehicle is provided. The virtual reality system includes a plurality of camera devices configured to be distributed about the vehicle, the camera devices sense an environment associated with the vehicle; and a controller that is configured to, by a processor, receive image data from the plurality of camera devices coupled to the vehicle, wherein the image data depicts an environment surrounding the vehicle; receive point of interest data associated with the environment of the vehicle; fuse the image data and the point of interest data; orient the fused image data based on a position of a user device; and render the oriented, fused data on a virtual reality display of the user device.

In various embodiments, the controller fuses based on a probabilistic optimization method. In various embodiments, the controller fuses further based on a fusing of inertia measurement unit data, global positioning system data, and the image data to determine a location, orientation, and speed of the vehicle in a first coordinate system. In various embodiments, the controller fuses further based on fusing image data and inertia measurement data to obtain a result and fusing the result with global positioning system data.

In various embodiments, the controller fuses based on a graph pose optimization. In various embodiments, the controller fuses further based on fusing global positioning system data and inertia measurement unit data to obtain a result and fusing the result with the image data.

In various embodiments, the controller fuses further based on fusing global positioning system data, inertia measurement unit data, camera data, and point of interest data into a single coordinate system; and transforming the fused data into a second coordinate system, wherein the second coordinate system is a of the user device. In various embodiments, the controller orients based on orienting the transformed data from the second coordinate system to a third coordinate system, wherein the third coordinate system is based on an orientation of the user device.

In various embodiments, the point of interest data includes at least one of a name, a logo, an address, contact information, sales information, hours of operation, historical facts relative to the point.

In another embodiment, a vehicle is provided. The vehicle includes a plurality of camera devices distributed about the vehicle, the camera devices sense an environment associated with the vehicle; and a controller that is configured to, by a processor, receive image data from the plurality of camera devices coupled to the vehicle, wherein the image data depicts an environment surrounding the vehicle; receive point of interest data associated with the environment of the vehicle; fuse the image data and the point of interest data; orient the fused image data based on a position of a user device; and render the oriented, fused data on a virtual reality display of the user device.

### BRIEF DESCRIPTION OF THE DRAWINGS

The exemplary embodiments will hereinafter be described in conjunction with the following drawing figures, wherein like numerals denote like elements, and wherein:

FIG. 1A is a functional block diagram illustrating a vehicle having a passenger virtual reality system, in accordance with various embodiments;

FIG. 1B is an illustration of cameras of the virtual reality system, in accordance with various embodiments;

FIG. 2 is a dataflow diagram illustrating a virtual reality module of the virtual reality system, in accordance with various embodiments; and

FIG. 3 is a flowchart illustrating a method for displaying virtual reality content to a passenger of a vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

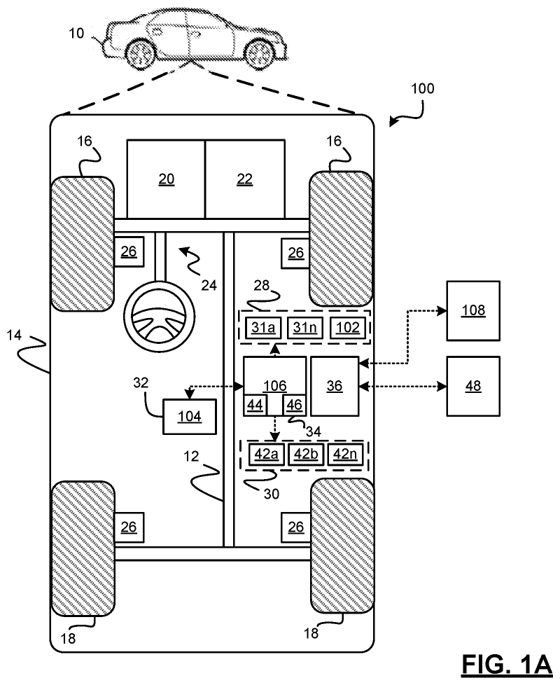

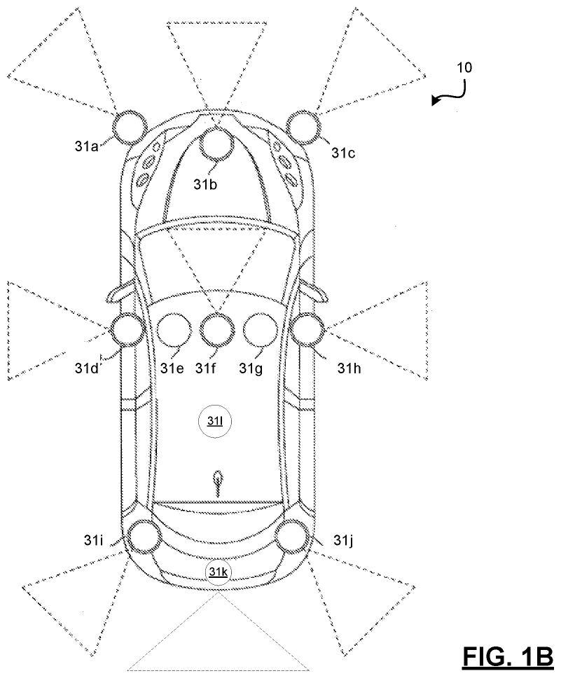

With reference to FIG. 1A, a virtual reality system shown generally at 100 is associated with a vehicle 10 in accordance with various embodiments. The virtual reality system generally includes a plurality of vehicle cameras 102, a data storage device 104, a controller 106, and a user display device 108. In general, the virtual reality system 100 receives sensor data from vehicle cameras 102, fuses the sensor data, and associates the fused data with a point of interest (POI) map stored in the data storage device 104 to generate an informative and entertaining augmented virtual reality experience that is displayed by the user display device 108. For example, the virtual reality system 100 displays the processed data to a passenger of the vehicle 10 through eyewear worn by the user.

As depicted in FIG. 1A, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 may be an autonomous vehicle and the virtual reality system 100 may be incorporated into the autonomous vehicle. The autonomous vehicle is, for example, a vehicle that is automatically controlled (fully or partially) to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 31a-31n that sense observable conditions of the exterior environment and/or the interior environment of the autonomous vehicle 10. The sensing devices 31a-31n can include, but are not limited to, radars, lidars, global positioning systems, optical cameras, thermal cameras, ultrasonic sensors, inertial measurement units, microphones, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features controlled by the one or more actuator devices 42a-42n can further include interior and/or exterior vehicle features such as, but are not limited to, doors, a trunk, and cabin features such as air, music, lighting, etc. (not numbered).

In various embodiments, one or more of the sensing devices 31a-31n are the vehicle cameras 102 or other imaging devices. The camera devices 102 are coupled to an exterior of the body 14 of the vehicle 10 and/or coupled to an interior of the vehicle 10 such that they may capture images of the environment surrounding the vehicle 10. For example, an exemplary embodiment of sensing devices 31a-31j that include camera devices 102 distributed about the vehicle 10 is shown in FIG. 1B. As shown, sensing devices 31a-31j are disposed at different locations and oriented to sense different portions of the surrounding environment in the vicinity of the vehicle 10. As can be appreciated, the sensing devices 31a-31j can include all of the same type of camera device or be a combination of any of the types of camera devices.

In the provided example, a first sensing device 31a is positioned at the front left (or driver) side of the vehicle 10 and is oriented 45° counterclockwise relative to the longitudinal axis of the vehicle 10 in the forward direction, and another sensor device 31c may be positioned at the front right (or passenger) side of the vehicle 10 and is oriented 45° clockwise relative to the longitudinal axis of the vehicle 10. Additional sensing devices 31i, 31j are positioned at the rear left and right sides of the vehicle 10 and are similarly oriented at 45° counterclockwise and clockwise relative to the vehicle longitudinal axis, along with sensing devices 31d and 31h positioned on the left and right sides of the vehicle 10 and oriented away from the longitudinal axis so as to extend along an axis that is substantially perpendicular to the vehicle longitudinal axis. The illustrated embodiment also includes a group of sensing devices 31e-31g positioned at or near the vehicle longitudinal axis and oriented to provide forward direction signals in line with the vehicle longitudinal axis.

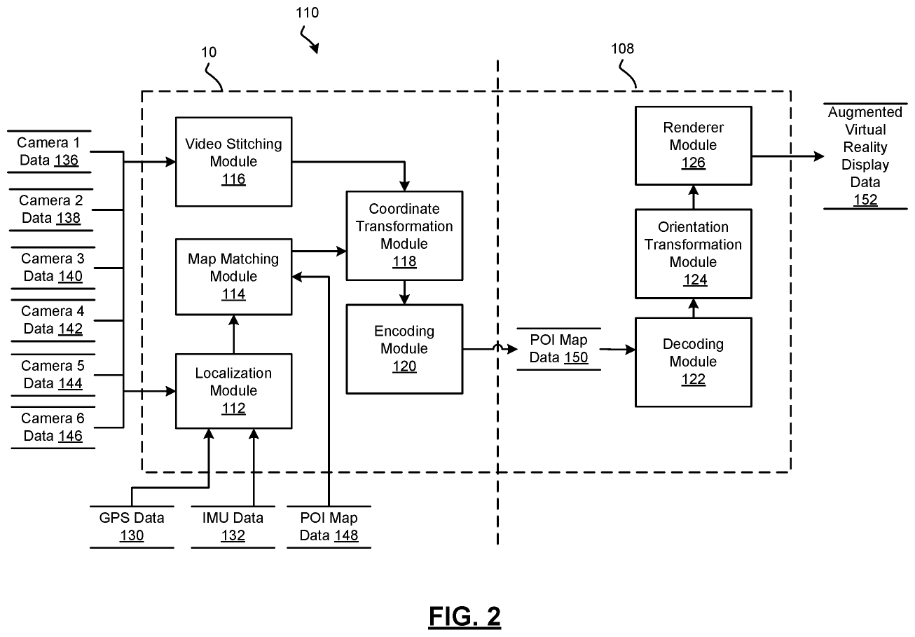

With reference back to FIG. 1A, the communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the vehicle 10. In various embodiments, the data storage device 32 stores defined maps of the navigable environment. In various embodiments, the data storage device includes the data storage device 104 and the defined maps include information associated with various points of interest. Such information can include, but is not limited to, names, logos, address, contact information, sales information, hours of operation, historical facts, and/or any other information relative to the points. In various embodiments, the POI information can include images depicting the information and that can be rendered over a virtual reality scene to provide an augmented reality. In various embodiments, the POI information can be separated into different classifications. The classifications can then be selected based on a viewer's interests.

In various embodiments, the defined maps and/or POI information may be predefined by and obtained from a remote system. For example, the defined maps and/or POI information may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the vehicle 10 based on the logic, calculations, methods, and/or algorithms. Although only one controller 34 is shown in FIG. 1A, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

In various embodiments, the controller 34 includes the controller 106 and includes one or more instructions embodied in a virtual reality module 110 that, when executed by the processor 44, receive image data from the sensing devices 31-31j such as the camera devices, receive GPS and/or IMU data, and process the received data to localize the vehicle 10, fuse the data into a 360 degree virtual reality scene with point of interest information. The instructions, when executed by the processor, further cause the virtual reality scene having augmented reality content to be displayed to a passenger wearing the user display device 108.

In various embodiments, the user display device 108 receives the virtual scene and displays a portion of the scene based on an orientation of the user device relative to the environment. The scene depicts a virtual reality of the environment around the vehicle and information relating to certain points of interest. The information can be selectively displayed based on an interest of the passenger. For example, a child passenger may be interested in different points of interest than an adult passenger.

Referring now to FIG. 2 and with continued reference to FIGS. 1A and 1B, a dataflow diagram illustrates the virtual reality module 110 of the virtual reality system 100 in more detail in accordance with various exemplary embodiments. As can be appreciated, various exemplary embodiments of the virtual reality module 110, according to the present disclosure, may include any number of modules and/or sub-modules. In various exemplary embodiments, the modules and sub-modules shown in FIG. 2 may be combined and/or further partitioned to similarly to provide a virtual reality experience including augmented reality data. In various embodiments, the virtual reality module 110 may be located all on the vehicle 10, part on the vehicle 10 and part on the user display device 108, and/or all on the user display device 108. In various embodiments, the virtual reality module 110 receives inputs from the one or more of the cameras 102, from other modules (not shown) within the virtual reality module 110, received from other controllers (not shown), and/or received from the data storage device 104. In various embodiments, the virtual reality module 110 includes a localization module 112, a map matching module 114, a video stitching module 116, a coordinate transformation module 118, an encoding module 120, a decoding module 122, an orientation transformation module 124, and a rendering module 126. For exemplary purposes, a dashed line illustrates an exemplary separation between functions implemented on the vehicle 10 and functions implemented on the user display device 108.

The localization module 112 receives as input GPS data 130, IMU data 132, and camera data 134. The localization module 112 determines an actual location (x={position, orientation, speed}) of the vehicle 10 with respect to the camera images (localizes the vehicle 10). In various embodiments, the localization module 112 localizes the vehicle 10 based on an Extended Kalman filter (EKF). As can be appreciated, the usage of EKF is just merely an example. It should be understood that other means of probabilistic inference optimization, such as Particle Filter, Pose Graph optimization, among many other alternatives, can be applied to solve the targeted problem. In one example, the localization module 112 fuses all sensor outputs including IMU data 132 (IMU), the GPS data 130 (GPS), and the camera data 136-146 (VO) to the EKF as:

$$[ \begin{matrix}IMU \\ GPS \\ VO\end{matrix} ] {\to }^{EKF} Fusion . \qquad ( 1 )$$

In another example, the localization module 112 fuses the data using a multi-tiered approach, where the GPS data 130 (GPS) and the IMU data 132 (IMU) are fused first and the output (VIO) of that fusion is then fused with the camera data 136-146 (VO) as:

$$\begin{matrix}[ \begin{matrix}IMU \\ VO\end{matrix} ] {\to }^{EKF} VIO ; and & ( 2 ) \\ [ \begin{matrix}VIO \\ GPS\end{matrix} ] {\to }^{EKF} Fusion . & ( 3 )\end{matrix}$$

In various embodiments, the localization module 112 localizes the vehicle 10 based on a Pose Graph Optimization methods. For example, the localization module 112 fuses the IMU data 132 (IMU), the GPS data 130 (GPS), and the camera data 136-146 (VO) using a pose graph optimization.

$$[ \begin{matrix}IMU \\ GPS \\ VO\end{matrix} ] {\to }^{PoseGraph} Fusion . \qquad ( 4 )$$

In another example, the localization module 112 fuses the data using a multi-tiered approach, where the camera data 136-146 (VO) and the IMU data 132 (IMU) are fused first and the output (GPS/IMU) of that fusion is then fused with the GPS data 130.

$$\begin{matrix}[ \begin{matrix}GPU \\ IMU\end{matrix} ] {\to }^{PoseGraph} {\to }_{EKF} GPS \text{/} IMU ; and & ( 5 ) \\ [ \begin{matrix}GPS \text{/} IMU \\ VO\end{matrix} ] {\to }^{PoseGraph} Fusion . & ( 6 )\end{matrix}$$

The map matching module 114 receives a POI map 148, and the determined location of the vehicle 10. The map matching module 114 retrieves POI information that is located near the vehicle 10. For example, the POI information can be retrieved for a defined radial proximity from the location of the vehicle 10. In various embodiments, the defined radial proximity may be selected based on the current speed of the vehicle 10. For example, the faster the vehicle 10 is going, the greater the defined radius. In another example, the slower the vehicle 10 is traveling, the slower the defined radius.

The video stitching module 116 receives the camera data 136-146 from the camera devices 102 of the vehicle 10. The video stitching module 116 stitches the image data to provide a 360 degree view of the environment surrounding the vehicle 10. The video stitching module 116 stitches the image data based on a location of each camera relative to the vehicle 10 and one or more pixel blending techniques. In various embodiments, the video stitching module 116 stitches image data based on feature matching and random sample consensus (RANSAC) method. For example, the image features includes Harris corners, ORB features, SIFT features and SURF features. The RANSAC with DLT method is used to compute the homography. Then the stitched image data is projected to spherical or cylindrical surface.

The coordinate transformation module 118 receives the image data and the associated POI information data and transforms the coordinates of each into a coordinate system of the user display device 108. In various embodiments, the coordinate transformation module 118 transforms the POI objects from world coordinate system to camera coordinate system. For example, the stitched camera's location and direction in world coordinate are computed in the localization module 112 by using SLAM method. The POI object's location in world coordinate is extracted from module 114. Then the module 118 transforms the world coordinate to camera coordinate based on the camera's intrinsic and extrinsic parameters.

The encoding module 120 receives the transformed image data and the associated POI information data and encodes the data for transmission. In various embodiments, the encoding can be, for example, according to WI-FI or wired communication protocols. The encoding module 120 then transmits the encoded data to the user display device 108.

The decoding module 122 receives as input the encoded data and decodes the received data. In various embodiments, the decoding can be, for example, according to WI-FI or wired communication protocols.

The orientation transformation module 124 receives the decoded data. The orientation transformation module 124 transforms the coordinates of the image data and the corresponding POI information into coordinates that are based on a current orientation of the user display device 108. For example, an orientation of the user display device 108 can be determined relative to a defined location when the user is wearing the device 108 and looking to the left, looking to the right, looking behind the vehicle, looking to the front of the vehicle, etc. and the image data that is displayed is oriented based on the direction the user is looking.

The rendering module 126 receives the oriented data and renders the data for display by the user display device 108.

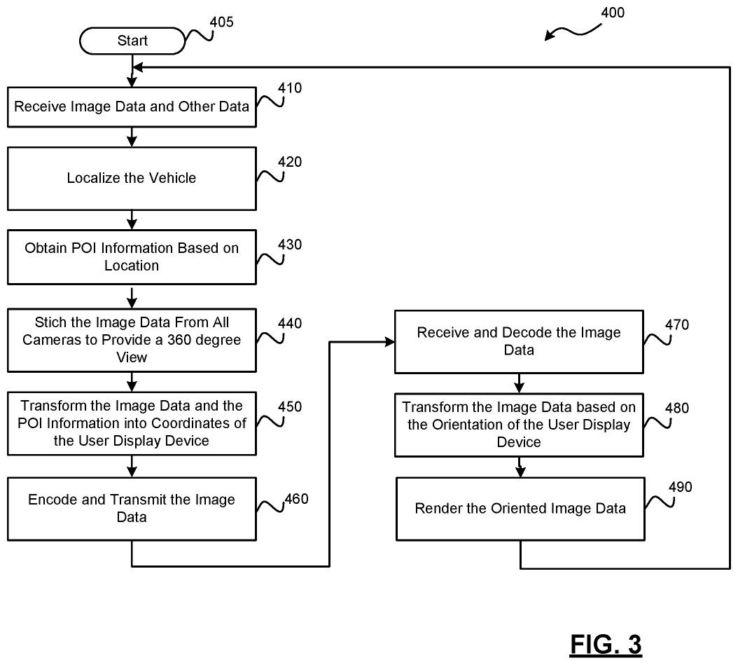

As shown in more detail with regard to FIG. 3 and with continued reference to FIGS. 1A, 1B, and 2, a flowchart illustrates a method 400 that can be performed by the virtual reality system 100 in accordance with the present disclosure. As can be appreciated in light of the disclosure, the order of operation within the method is not limited to the sequential execution as illustrated in FIG. 3, but may be performed in one or more varying orders as applicable and in accordance with the present disclosure. In various embodiments, the method 400 can be scheduled to run based on one or more predetermined events, and/or can run continuously during operation of the vehicle 10.

In one example, the method may begin at 405. Sensor data is received from the camera devices, the IMU, and the GPS at 410. The vehicle 10 is localized at 420, for example, based on an extended Kalman Filter and/or a pose graph optimization as discussed above. The location of the vehicle 10 is matched to a location on the POI map and the corresponding POI information is retrieved at 430. The camera data is stitched to provide a 360 degree view at 440. The POI map information and the camera data are then transformed into a coordinate system of the user device at 450 and encoded for transmission at 460. Thereafter, the user display device 108 receives and decodes the received data at 470 and transforms the data based on the orientation of the user display device 108 at 480 as discussed above and rendered at 490. The method then continues with receiving the sensor data and processing the sensor data in order to display augmented virtual reality content to the user. In this manner, the method provides for a way to entertain a user through displaying to the user an augmented virtual reality of the environment that the vehicle 10 is currently traveling.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method of entertaining a passenger of a vehicle by providing an immersive experience, comprising:
receiving image data from a plurality of camera devices coupled to the vehicle, wherein the image data depicts an environment surrounding the vehicle;
receiving point of interest data associated with the environment of the vehicle;
fusing, by a processor, the image data and the point of interest data based on a localization method of the plurality of camera devices;
orienting, by the processor, the fused image data based on a position of a user device; and
rendering, by the processor, the oriented, fused data on a virtual reality display of the user device.

2. The method of claim 1, wherein the fusing is based on a probabilistic optimization method.

3. The method of claim 2, wherein the fusing is further based on a fusing of inertia measurement unit data, global positioning system data, and the image data to determine a location, orientation, and speed of the vehicle in a first coordinate system.

4. The method of claim 2, wherein the fusing is further based on fusing image data and inertia measurement data to obtain a result and fusing the result with global positioning system data.

5. The method of claim 1, wherein the fusing is based on a graph pose optimization.

6. The method of claim 5, wherein the fusing is further based on fusing global positioning system data and inertia measurement unit data to obtain a result and fusing the result with the image data.

7. The method of claim 1, wherein the fusing is based on a graph pose optimization and an extended Kalman filter.

8. The method of claim 1, wherein the fusing further comprises:
fusing global positioning system data, inertia measurement unit data, camera data, and point of interest data into a single coordinate system; and
transforming the fused data into a second coordinate system, wherein the second coordinate system is a coordinate system of the user device.

9. The method of claim 8, wherein the orienting comprises orienting the transformed data from the second coordinate system to a third coordinate system, wherein the third coordinate system is based on an orientation of the user device.

10. The method of claim 1, wherein the point of interest data includes at least one of a name, a logo, an address, contact information, sales information, hours of operation, historical facts relative to the point of interest.

11. A virtual reality system for a vehicle, comprising:
a plurality of camera devices configured to be distributed about the vehicle, the plurality of camera devices sense an environment associated with the vehicle; and
a controller that is configured to, by a processor, receive image data from the plurality of camera devices coupled to the vehicle, wherein the image data depicts an environment surrounding the vehicle; receive point of interest data associated with the environment of the vehicle; fuse the image data and the point of interest data based on a localization method of the plurality of camera devices; orient the fused image data based on a position of a user device; and render the oriented, fused data on a virtual reality display of the user device.

12. The system of claim 11, wherein the controller fuses based on a probabilistic optimization method.

13. The system of claim 12, wherein the controller fuses further based on a fusing of inertia measurement unit data, global positioning system data, and the image data to determine a location, orientation, and speed of the vehicle in a first coordinate system.

14. The system of claim 12, wherein the controller fuses further based on fusing image data and inertia measurement data to obtain a result and fusing the result with global positioning system data.

15. The system of claim 11, wherein the controller fuses based on a graph pose optimization.

16. The system of claim 15, wherein the controller fuses further based on fusing global positioning system data and inertia measurement unit data to obtain a result and fusing the result with the image data.

17. The system of claim 11, wherein the controller fuses further based on fusing global positioning system data, inertia measurement unit data, camera data, and point of interest data into a single coordinate system; and transforming the fused data into a second coordinate system, wherein the second coordinate system is a coordinate system of the user device.

18. The system of claim 17, wherein the controller orients based on orienting the transformed data from the second coordinate system to a third coordinate system, wherein the third coordinate system is based on an orientation of the user device.

19. The system of claim 11, wherein the point of interest data includes at least one of a name, a logo, an address, contact information, sales information, hours of operation, historical facts relative to the point of interest.

20. A vehicle, comprising:
a plurality of camera devices distributed about the vehicle, the plurality of camera devices sense an environment associated with the vehicle; and
a controller that is configured to, by a processor, receive image data from the plurality of camera devices coupled to the vehicle, wherein the image data depicts an environment surrounding the vehicle; receive point of interest data associated with the environment of the vehicle; fuse the image data and the point of interest data based on a localization method of the plurality of camera devices; orient the fused image data based on a position of a user device; and render the oriented, fused data on a virtual reality display of the user device.
